(19) United States
(12) Patent Application Publication
(10) Pub. No.: US 2009/0077290 A1
(43) Pub. Date: Mar. 19, 2009

(54) CONTROLLER FOR PROCESSING APPARATUS

(75) Inventor: Anthony Craig DOLWIN, Bristol (GB)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 12/212,114

(22) Filed: Sep. 17, 2008

(30) Foreign Application Priority Data
Sep. 17, 2007 (GB) 0718100.1

(51) Int. Cl. G06F 13/00

(52) U.S. Cl. 710/110

(57) ABSTRACT

A computer apparatus comprises a master module and a slave module such that the master module is able to send a functional request to the slave module for the execution by the slave module of a requested function. The master module comprises dynamic voltage scaling (DVS) means operable to establish a DVS control scheme for the master processing module, and DVS liking means operable to relate the DVS control scheme to the slave processing module.

This invention relates to a controller for controlling processor apparatus and particularly to a controller employing dynamic voltage scaling. It is particularly, but not exclusively, concerned with control of a CMOS based integrated circuit.

It is well known that the maximum operating frequency of CMOS technology increases generally with supply voltage. Using this, power consumption of a CMOS device can be controlled by operating the device at the lowest clock frequency permitted for a particular operating requirement and taking the opportunity arising from this to limit supply voltage. Various techniques have been put forward in the art to take advantage of this, collectively known as Dynamic Voltage Scaling (DVS).

UK Patent Application GB2403823 describes a method for implementing the dynamic scaling of voltages on a set of resources while the resources continue to execute operations. This technique is especially applicable to software defined radio. The DVS scheme disclosed therein ramps up the supply voltage and clock frequency during the execution of an operation by a processing resource. By increasing the voltage-frequency during the execution of an operation, the resource will use less power if the operation uses fewer cycles than the worst-case execution cycle count.

UK Patent Application GB2410344 describes implementation of an intra-operation DVS scheme to a reconfigurable application in a hard real-time heterogeneous System on a Chip (SoC) environment.

DVS is currently in use by companies such as ARM, Intel and Transmeta. This is demonstrated by the following two publications by ARM and a third by Transmeta:
S. M. Martin, et al, “Combined Dynamic Voltage Scaling and Adaptive Body Biasing for Low Power Microprocessors Under Dynamic Workloads”, http://www.arm.com/pdfs/dvsabb-ICCAD2002.pdf;
P. Morris, P. Watson, “Automated Low-Power Implementation Methodology” ARM Developers Conference-Information Quarterly, Vol. 4, No. 3, 2005; and
M. Fleischmann, “Longun™ Power Management”, www.transmeta.com/pdfs/paper_mfleischmann_{—}17jan01.pdf, 2001.

The schemes used by these device designers are based on uni-processor design with a common clock. The DVS schemes implemented by ARM, Intel and Transmeta in the papers identified above only apply to a single voltage-frequency domain. That is, only one domain is modified in voltage and frequency as a result of a decision by the DVS management entity.

A number of papers discuss combining globally asynchronous, locally synchronous (GALS) architectures with DVS.

For instance, “Dynamic speed/voltage scaling for GALS processors”, (S. Chan, A. Eswaran, http://www.ece.cmu.edu/˜schen1/ece743) discusses how DVS can be used to ensure certain stages in a processor operate more slowly than usual, when later stages take longer to complete tasks. By running more slowly and at a lower voltage, overall power consumption is reduced.

“Power Efficiency of Voltage Scaling in Multiple Clock, Multiple Voltage Cores” (A. Iyer, D. Marculescu, Conference on Computer-Aided Design (ICCAD), November 2002) and “Power-Performance Evaluation of Globally Asynchronous, Locally Synchronous Processors” (A. Iyer and D. Marculescu, International Symposium on Computer Architecture (ISCA), May 2002) discuss the benefits of GALS when combined with DVS.

“Request-Driven GALS Technique for Datapath Architectures” (M. Krstic, E Grass, Proc. of the 3rd ACiD-WG Workshop, Heraklion, Jan. 27-28, 2003, Greece, session 2 (2003)) describes how the clock frequency of a second module can be dynamically modified by monitoring the status of a FIFO feeding to it i.e. when the FIFO is empty the clock is stopped. This paper is based on a thesis by Krstic at the Brandenburgischen Technischen Universität, Cottbus.

US Patent Application US 2006/161797 describes an asynchronous wrapper for use in a GALS architecture. It describes how an external signal is used to set the internal synchronous clock of a processing resource.

In general terms, an aspect of the invention provides a modification of the approach taken in GB2410344. In that patent application, an approach is disclosed which uses an adaptive DVS scheme, but which relies on a controllable clock directly modifying the execution time for a task on a module. If the number of cycles taken to complete the task is a function of a second module, then the benefits of the DVS scheme are diminished. Typically, the cycle count of a task on the first module might be dependent on a second module if the task needs the second module to perform a function. Some examples of possible functions to be transferred to another processing resource are:
Hardware accelerators (turbo decoder)
Memory transfer (DMA)
Slave processors

An aspect of the present invention provides a mechanism where the processing time for a slave module is linked to its master in such a way that the DVS scheme supported by the master can have the greatest benefit to the overall processing apparatus. In this aspect of the invention, information concerning the clock frequency, calculated by the master DVS manager, is inherited (or reused) by sub-modules whenever the master requests a function from the sub-module.

Another aspect of the invention provides a computer apparatus comprising a master processing module and at least one sub-module, dynamic voltage scaling means being associated with the master module and operable to calculate dynamically an operating frequency for the master module, and wherein said sub-module is operable to use said operating frequency when accessed by the master module.

In such a case, it can be said that the sub-module ‘inherits’ the operating frequency of the master module.

In an embodiment of the invention, mapping means may be provided operable to map the master clock frequency to a generic speed request. This generic speed request can then be sent to the sub module in terms which it can interpret independently. This enables the sub-module to interpret a received generic speed request to take account of local processing capabilities or conditions, to achieve a result desired by the master module. For instance, the sub-module may interpret the speed request according to its processing type.

A further aspect of the invention provides a computer processing apparatus comprising a plurality of processing modules, wherein at least one of said modules comprises dynamic voltage scaling means, and is operable to send to a further of said modules a functional request message for processing by said further module, wherein said functional request message is, in use, accompanied by a processing speed message.

In said further aspect, the further module may be responsive to receipt of a speed message by controlling its clock frequency and/or operating voltage.

A further aspect of the invention provides a computer processing apparatus comprising a plurality of modules, wherein at least one module comprises dynamic voltage scaling means and is operable to interact with another module by supplying it with a speed request associated with a functional request. Responsive to receiving a speed request, the module in receipt thereof is operable to interpret the speed request by control of at least one processing parameter governing execution of the associated functional request. The processing parameter may be the expected time for execution of the functional request.

A further aspect of the invention provides a computer processing apparatus comprising a plurality of modules, wherein at least one module comprises dynamic voltage scaling means and is operable to interact with another module by supplying it with a clock signal when it requests said other module to execute a function. In addition to the clock signal, the module may be operable to supply a supply voltage to said other module when requesting said other module to execute a function.

A further aspect of the invention provides a computer processing apparatus comprising a master module and a slave module, the master module being operable to send a functional request to said slave module for execution by said slave module of a requested function, the master module comprising dynamic voltage scaling (DVS) means operable to establish a DVS control scheme for the master processing module, and DVS linking means operable to relate the DVS control scheme to said slave processing module.

A further aspect of the invention provides a method of controlling a computer processing apparatus comprising a master module and a slave module, comprising establishing a DVS control scheme for the master module, relating the DVS control scheme to said slave module, associating a DVS control request with a functional request wherein the DVS control request is in accordance with the slave module related DVS control scheme, and sending said functional request and said DVS control request from the master module to said slave module for execution by said slave module of a requested function in accordance with said DVS control request.

Aspects of the invention can be implemented, by way of example, in a ‘system an a chip’ (SoC) context, for instance for a mobile telephone, or for execution of a video CODEC, for Games Equipment, or in base stations or access points. That is, aspects of the invention can be applied to a situation wherein a multi-processor architecture is provided, wherein there is a requirement to manage and possibly to minimise power consumption.

Aspects of the invention can be implemented using software components, for execution by broadly generic computer hardware, such as a DSP or an FPGA. Such software components could be delivered by physical storage media, or by a signal.

Further possible aspects, features and advantages of the invention will become apparent from the follow description of specific embodiments thereof, with reference to the accompanying drawings, in which:

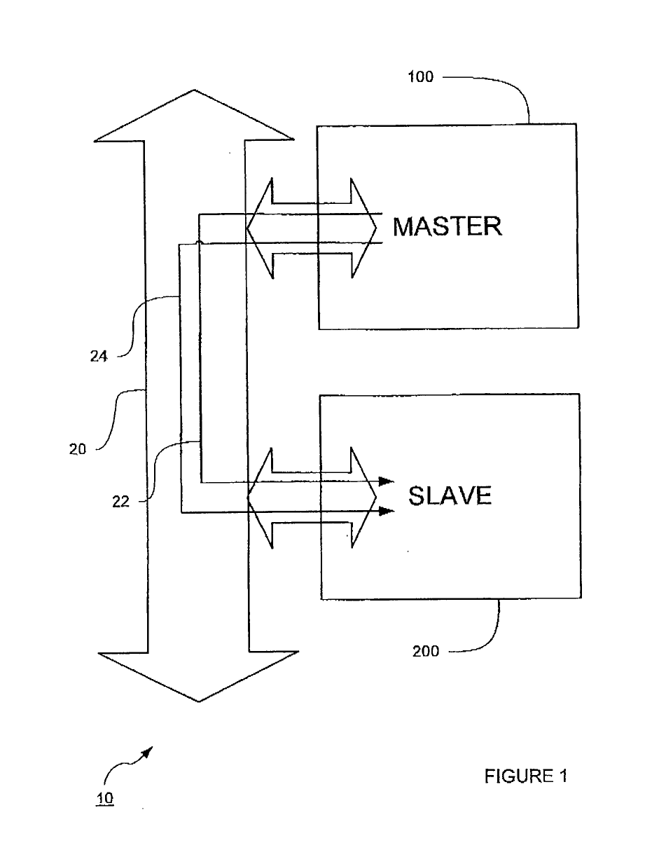

FIG. 1 is a schematic diagram of a computer processing apparatus in accordance with a first specific embodiment of the invention;

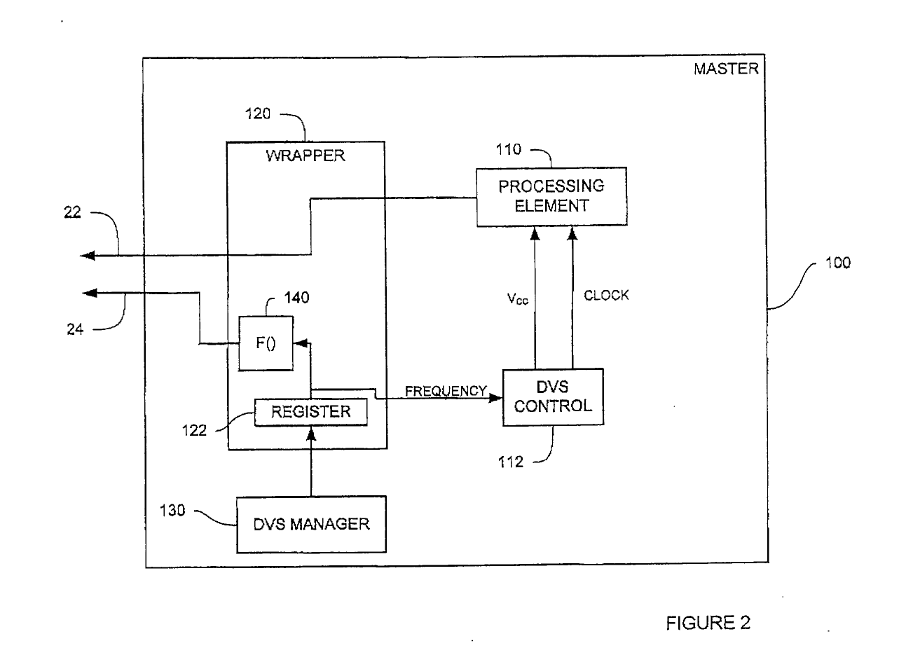

FIG. 2 is a schematic diagram of a master processor of the computer processing apparatus illustrated in FIG. 1;

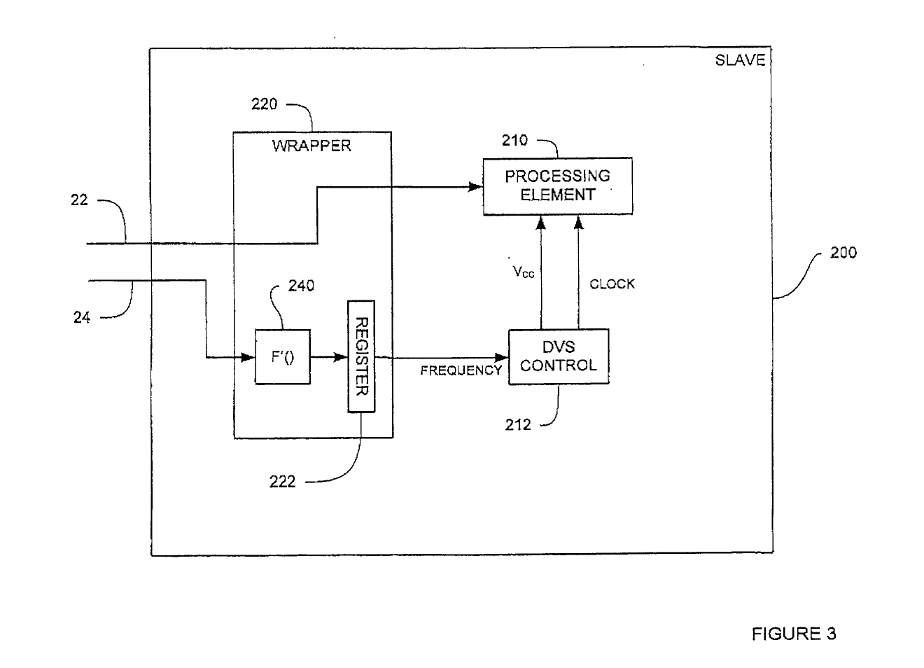

FIG. 3 is a schematic diagram of a slave processor of the computer processing apparatus illustrated in FIG. 1;

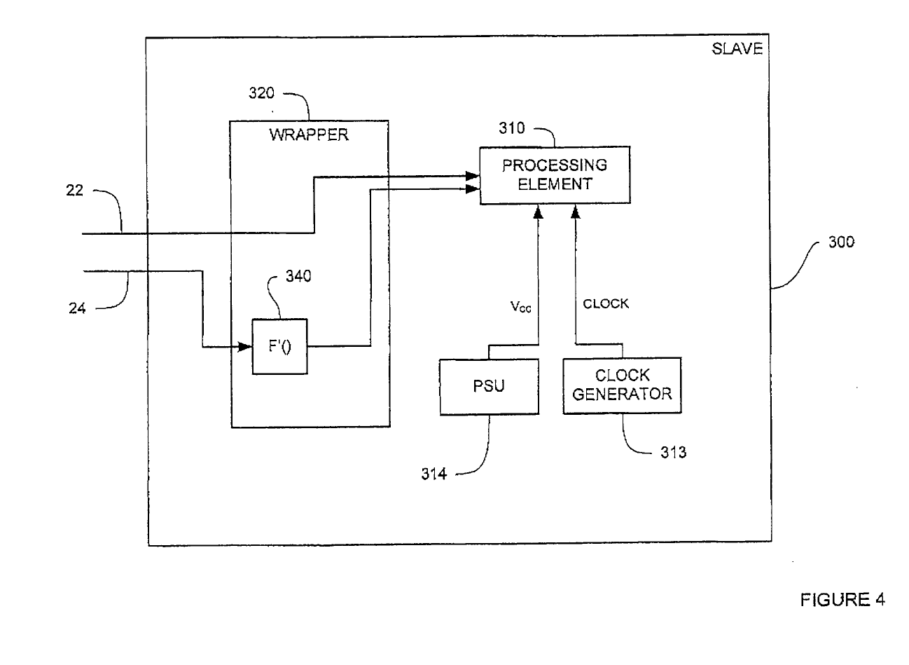

FIG. 4 is a schematic diagram of a slave processor, in accordance with a second embodiment of the invention, for incorporation into the computer processing apparatus illustrated in FIG. 1 instead of the slave processor illustrated in FIG. 3;

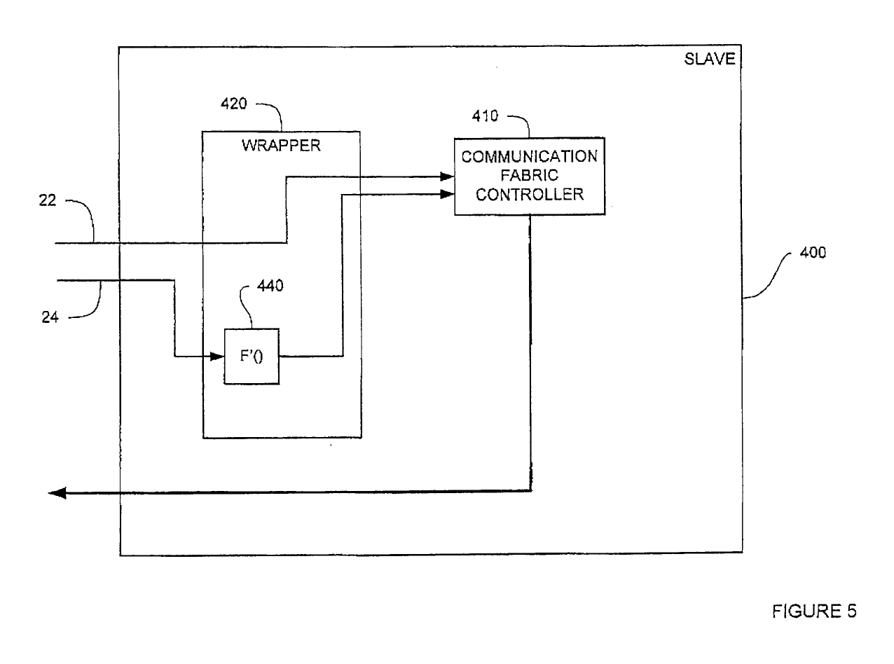

FIG. 5 is a schematic diagram of a slave processor, in accordance with a third embodiment of the invention, for incorporation into the computer processing apparatus illustrated in FIG. 1 instead of the slave processor illustrated in FIG. 3; and

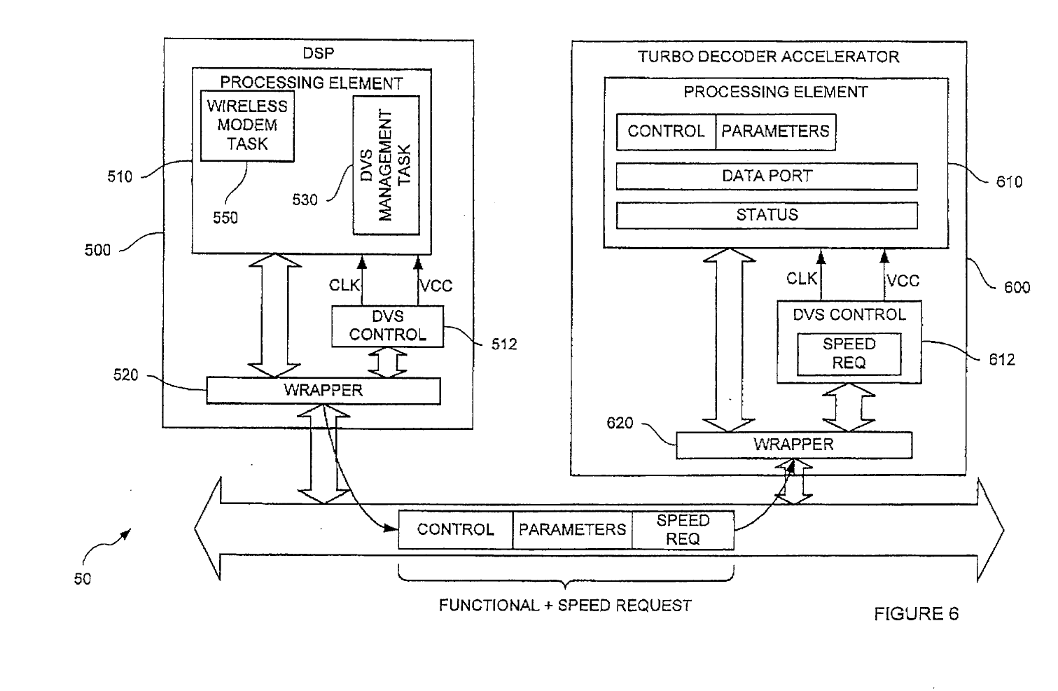

FIG. 6 is a schematic diagram of a wireless modem implemented in accordance with the computer processing apparatus of the first specific embodiment illustrated in FIG. 1.

FIG. 1 illustrates a first specific embodiment of the invention, in which a computer processing apparatus 10 is illustrated. It will be appreciated by the reader that the illustrated example is but representative, and more complex apparatus including a larger number of processing elements can be provided. In this case, a master processor 100 and a slave processor 200 are provided, each of which is operable to access a bus 20 for transmission of messages between the two processing components 100, 200. In conventional manner, the master can send a function request 22 to the slave, to cause the slave 200 to perform a function for which it is better suited than the master 100. It will be appreciated that the reasons why the master request to a slave 200 may depend on a number of factors, not just suitability for a particular task to be performed.

In addition to this, and in accordance with this specific embodiment of the invention, a speed request 24 is sent alongside the function request 22 by the master 100 to the slave 200.

The master processing unit 100 is illustrated in further detail in FIG. 2. The master processing unit 100 is compliant with the “globally asynchronous locally synchronous” (GALS) architecture, so comprises a processing element 110 operable in a synchronous domain, under the control of a DVS control unit 112 which supplies a clock and an associated supply voltage on the basis of a requested frequency. The frequency is determined in a wrapper unit 120 which is an interface between asynchronous and synchronous architectures. The wrapper unit 120 comprises a frequency register 122 which is programmed by a DVS manager 130.

In addition to outputting the frequency for use by the DVS control unit 112, the register 122 passes the frequency to a functional block 140. This block converts the register frequency value for the clock speed in the master processor unit 100, into a generic speed request. This generic speed request is then output as signal 24 previously described. This signal 24 is output alongside a functional request signal 22 output by the processing element 110. A functional request signal 22 is output when the master module makes a request for a service from a different clock domain. An example could be a memory transfer request, or a hardware accelerator operation, such as to channel decode a block of data.

Similarly, a speed request is sent for use by the slave module 200 receiving the functional request 22. This speed request 24 is used by the slave module 200 to determine the mechanism of execution.

The effect of the speed request is to alter the time for which the master processing unit 100 will wait for the slave processing unit 200 to complete its operation. The master processing unit 100 selects the value of the speed request based on the frequency voltage setting under which it is currently executing tasks. That is, if the master processing unit 100 is operating at a relatively high master clock frequency (as governed by the DVS control unit 112), the speed request will correspondingly be high. Conversely, if the master processing unit 100 currently executes at a relatively low speed, the speed request will consequently be adjusted to a lower level.

The speed request can be a generic value, for interpretation by the slave processing unit 200 according to its type and structure.

FIG. 3 illustrates in further detail the structure of the slave processing unit 200 of the first specific embodiment of the invention. The slave processing unit 200 comprises a processing element 210, which is synchronous in nature and therefore governed by a DVS control unit 212, supplying a supply voltage and a clock thereto. The DVS control unit 212 is governed by a frequency quantity, which is extracted from a wrapper unit 220 comprising a register 222 generating the frequency signal. The register 222 generates the frequency signal on the basis of a functional block 240, in receipt of a speed request signal 24. Consequently, a functional request 22 received by the processing element 210 can be processed according to DVS conditions governed by the speed request 24.

The functional block 240 is architecture specific, and is designed for the capabilities of the slave unit 200. The block 240 converts the speed request into a form suitable for the slave processing unit 200.

This allows the slave processing unit 200 to interpret the speed request in accordance with its own capabilities. It will be recognised by the reader that different types of modules may interpret the speed request differently. In addition, each processing unit may also have the capacity to modify its operating voltage or frequency to match the requested speed. This will allow for further saving in power consumption in the slave processing unit.

The following table sets out a correspondence between the master clock frequency output by the DVS control unit 112 of the master unit 100, with a generic speed request value, and with a priority value on the shared bus 20.

| | | Priority Value on |
|---|---|---|
| | | Shared Bus |
| Master Clock | Generic Speed | (0 = lowest |
| Frequency | Request Value | priority |
| 50 Mhz | 0 | 0 |
| 70 Mhz | 1 | 2 |
| 90 Mhz | 2 | 4 |
| 110 Mhz | 3 | 6 |
| 130 Mhz | 4 | 8 |
| 150 Mhz | 5 | 10 |
| 170 Mhz | 6 | 12 |
| 190 Mhz | 7 | 14 |

FIG. 4 illustrates a schematic diagram of a second specific embodiment of a slave unit 300. Again, the slave unit 300 comprises a processing element 310 operable to respond to a functional request 22 received on the bus. The processing element is governed in its ability to do this by means of a supply voltage VCC and a clock. However, in this case, the clock is generated by a clock generator 313, and the supply voltage is generated by a power supply unit 314.

The wrapper unit 320 is also modified from the wrapper unit 220 of the first embodiment. The wrapper unit now comprises a functional block 340 which is operable to interpret received speed requests 24 into configuration commands for the processing element 310. Thus, there is no direct DVS control on the slave unit of the second embodiment. The slave unit however does not just adopt the DVS control of the master unit 100, but instead interprets master unit speed requests 24 and provides local conditions in terms of configuration of the processing element 310 to enable tasks to be completed in an effective manner.

For example, if the processing element 310 is a multithreaded processor, the processor can allocate different time slots to the thread associated with the function request. This will enable priority tasks to be completed more quickly, or low priority tasks to be completed more slowly, without DVS at the slave.

A third embodiment of the slave unit 400 is illustrated in FIG. 5. This example is particularly relevant wherein the processing apparatus 10 comprises a shared communication fabric. The slave 400 of this example comprises a wrapper 420 which now includes a functional block 422 which interprets speed requests into a control signal for a communication fabric controller 412. The communication fabric controller 412 manages access to the shared communication fabric. It is thus a direct memory access (DMA) controller. The control signals are operable to cause the communication fabric controller 412 to modify its operating voltage and frequency to match the requested speed represented by the speed request 24. This allows for further saving in power consumption in the slave module.

Whereas in the thesis by Krstic, the clock speed of a slave module is determined by the status of the FIFO used to transfer data into the sub-module, this means that if no data is supplied, the clock used to drive the associated processing logic is switched off. The approach identified above allows for finer and more precise control of the operating mode and/or clock frequency of slave modules employed by a master module.

The FIFO technique of Krstic has a high latency associated with it. The technique described above in accordance with the specific embodiments of the invention explicitly states the speed at which a slave module should run when the data is supplied and so avoids the lag caused by the FIFO buffer.

Simple GALS/DVS schemes which only allow static setting of clock frequency and voltage do not take advantage of power savings possible due to the actual processing complexity being distributed i.e. having a mean and max value. By allowing sub-modules to inherit clock information, a communications network can take advantage of this aspect of power saving opportunities.

This approach can be used to reduce power consumption in any complicated CMOS based electronic system. Typically, it could be used in a large SoC with multiple processing elements. However, it could also be applied to multi-processor designs such as the CELL. These electronic systems could then be used for sophisticated applications such as the base band processing in a wireless phone or base station or in a games machine.

Embodiments of the invention will supply performance benefits when an application has variable complexity and requires the operating voltage and clock frequency to track the workload of the platform.

As a practical example, FIG. 6 depicts a wireless modem system 50 comprising a digital signal processor (DSP) 500 executing the signal processing stages of the modem as well as a DVS management controller, as separate tasks, and a hardware accelerator 600 for implementing a turbo decoder. Both modules 500, 600 have their own clock and voltage generator (DVS Controller 512, 612 respectively), and processing elements (510, 610 respectively). A wrapper 520 is provided in the DSP for associating information with an execution request and for unwrapping information received from another processing entity in the system 50. Likewise, a wrapper 620 is provided in the turbo decoder 600 for unwrapping information associated with an execution request received from the DSP 500, and also for associating items of information with each other for return to the DSP 500.

That is, this is a practical example of the first embodiment of the invention described above with reference to FIGS. 1 and 2. A DVS management task 530 defined in a processing element 510 of the DSP 500 provides the function of a DVS manager. The DVS manager in the DSP determines the clock frequency for the DSP at any particular time to ensure deadlines are achieved and power consumption is minimised.

A wireless modem task 550 is also defined in the DSP processing element 510, to provide the signal processing functions referred to above in connection with the modem capability of the wireless modem system 50. The wireless modem task 550, when requesting the turbo decoder 600 to execute, also includes a speed request with the functional request. This speed request is based on the speed currently set by the DVS manager 530. The speed request is written into a register in the turbo decoder's DVS controller 612 at the same time as the control bits and parameters are written into their associated registers. In this way, the turbo decoder can be set a DVS profile suitable to its own hardware capabilities but also reflecting the overall system requirements as managed from the DSP 500.

1. A computer processing apparatus comprising a master module and a slave module, the master module being operable to send a functional request to said slave module for execution by said slave module of a requested function, the master module comprising dynamic voltage scaling (DVS) means operable to establish a DVS control scheme for the master processing module, and DVS linking means operable to relate the DVS control scheme to said slave processing module.

2. Apparatus in accordance with claim 1 wherein said linking means is operable to send a DVS control message to said slave module alongside a functional request from said master module.

3. Apparatus in accordance with claim 2 wherein said DVS means is operable to determine clock frequency information defining a clock frequency for said master processing module, and wherein said linking means is operable to transfer said clock frequency information to said slave module in said DVS control message in conjunction with said functional request.

4. Apparatus in accordance with claim 1 wherein said DVS means is operable to calculate dynamically an operating frequency for the master module, and wherein said linking means is operable to send a DVS control message alongside a functional request, said DVS control message indicating said operating frequency to said slave module.

5. Apparatus in accordance with claim 1 wherein the master module further comprises DVS control information mapping means operable to map information defining a DVS control scheme for use by said master module into a generic speed request, said linking means being operable to send a generic speed request with a functional request, and wherein said slave module comprises generic speed information receiving means operable to cause said slave module to operate in accordance with said generic speed request.

6. Apparatus in accordance with claim 5 wherein said generic speed information receiving means is operable to map said generic speed information request to one of a plurality of available operating frequencies.

7. Apparatus in accordance with claim 5 wherein said generic speed information receiving means is operable to map said generic speed information request to one of a plurality of available supply voltages.

8. Apparatus in accordance with claim 5 wherein said generic speed information receiving means is operable to map said generic speed information request to one of a plurality of available operating speeds.

9. Apparatus in accordance with claim 5 wherein said generic speed information receiving means is operable to map said generic speed information request to a priority for a functional request sent with said generic speed information request.

10. A method of controlling a computer processing apparatus comprising a master module and a slave module, comprising establishing a DVS control scheme for the master module, relating the DVS control scheme to said slave module, associating a DVS control request with a functional request wherein the DVS control request is in accordance with the slave module related DVS control scheme, and sending said functional request and said DVS control request from the master module to said slave module for execution by said slave module of a requested function in accordance with said DVS control request.

11. A method in accordance with claim 10 and including determining clock frequency information defining a clock frequency for said master module, and transferring said clock frequency information to said slave module in said DVS control request in conjunction with said functional request.

12. A method in accordance with claim 10 and including calculating dynamically an operating frequency for the master module, and sending a DVS control request alongside a functional request, said DVS control request indicating said operating frequency to said slave module.

13. A method in accordance with claim 10 and including mapping said information defining a DVS control scheme for use by said master module into a generic speed request, and sending said generic speed request with said functional request, receiving said generic speed request at said slave module such that said slave module is caused to operate in accordance with said generic speed request.

14. A method in accordance with claim 13 and including mapping, at said slave module, said generic speed information request to one of a plurality of available operating frequencies.

15. A method in accordance with claim 13 and including mapping, at said slave module, said generic speed information request to one of a plurality of available supply voltages.

16. A method in accordance with claim 13 and including mapping, at said slave module, said generic speed information request to one of a plurality of available operating speeds.

17. A method in accordance with claim 13 and including mapping, at said slave module, said generic speed information request to a priority for a functional request sent with said generic speed information request.

18. A computer program product comprising computer executable instructions which, when loaded on a computer, cause said computer to perform a method in accordance with any one of claims 10 to 17.
